(19) United States
(12) Patent Application Publication
(10) Pub. No.: US 2018/0034128 A1
(43) Pub. Date: Feb. 1, 2018

(54) ANTENNA MODULE

(71) Applicant: Peiker Acustic GmbH & Co. KG, Friedrichsdorf (DE)

(72) Inventor: Jens LACHNITT, Alsfeld (DE)

(73) Assignee: Peiker Acustic GmbH & Co. KG, Friedrichsdorf (DE)

(21) Appl. No.: 15/678,663

(22) Filed: Aug. 16, 2017

Related U.S. Application Data
(63) Continuation of application No. PCT/EP2015/080492, filed on Dec. 18, 2015.

(30) Foreign Application Priority Data
Feb. 17, 2015 (DE) 10 2015 102 259.1
Mar. 25, 2015 (DE) 10 2015 104 543.5

(51) Int. Cl. H01Q 1/12; H01Q 1/32

(52) U.S. Cl. CPC H01Q 1/1214; H01Q 1/3275; H01Q 1/005

(57) ABSTRACT

The invention concerns an antenna module for a vehicle. The lower assembly comprises a locking mechanism and the upper assembly comprises a counter locking mechanism, wherein the locking mechanism is able to be locked to or unlocked from the counter locking mechanism, and wherein the locking mechanism is able to be actuated so as to avoid, when actuating same, exerting a force that acts in a joining direction.

### CROSS REFERENCE TO RELATED APPLICATIONS

This application is a continuation of International Application No. PCT/EP2015/080492 filed Dec. 18, 2015, which designated the United States, and claims the benefit under 35 USC §119(a)-(d) of German Application No. 10 2015 102 259.1 filed Feb. 17, 2015 and German Application No. 10 2015 104 543.5 filed Mar. 25, 2015, the entireties of which are incorporated herein by reference.

### FIELD OF THE INVENTION

The present invention relates to an antenna module.

### BACKGROUND OF THE INVENTION

An antenna module for a vehicle is known from DE 295 00 961 UI, wherein the antenna module comprises an upper assembly, which is connected to at least two antennas, and a lower assembly, wherein the upper assembly comprises as a first electrical contact component at least two coaxial connections, wherein the lower assembly comprises as a second electrical contact component at least two coaxial connections, wherein the upper assembly is secured to a body component of the vehicle, wherein the lower assembly is attachable to the upper assembly and wherein the lower assembly is positionable and/or attachable to the upper assembly by a joining movement along a joining direction. The drawback to such an antenna module is that the connection between the upper assembly and the lower assembly occurs simply by plugging in. This does not ensure a secure contacting.

### SUMMARY OF THE INVENTION

The object of the present invention is to develop an antenna module in which an electrical connection between the upper assembly and the lower assembly is guaranteed to be durable even under rather large loads and in which large installation forces are also avoided. Furthermore, the problem which the invention proposes to solve is to enable a simple one-hand installation of the second assembly on the first assembly.

In the antenna module according to the present invention, the lower assembly comprises a locking mechanism and the upper assembly comprises a counter locking mechanism, wherein the locking mechanism is able to be locked to or unlocked from the counter locking mechanism, and wherein the locking mechanism is able to be actuated so as to avoid, when actuating same, exerting a force that acts in a joining direction. Thanks to an additional mechanical locking of the second assembly on the first assembly, a durable and reliable contacting is assured, since this avoids the coaxial connections having to constantly withstand holding forces, especially in the form of tensile forces. Furthermore, the actuating force necessary to actuate the locking mechanism is only applied such that no pressure is created in the joining direction which would act in undesirable manner on the roof of the vehicle.

Furthermore, it is provided that the coaxial connections of the upper assembly are designed as coaxial plugs and the coaxial connections of the lower assembly are designed as coaxial sockets. In this way, the lower assembly has no projecting plug parts which might cause damage during the installation.

Furthermore, it is provided that the upper assembly is outfitted with a centering mechanism between its coaxial connections and projecting beyond its coaxial connections counter to a joining direction and the lower assembly is outfitted with a receiving mechanism for the centering mechanism arranged between its coaxial connections. This enables an easy orienting of the lower assembly to the upper assembly before the oppositely situated coaxial connections come into contact.

It is also provided that the antenna module is outfitted with a shock absorbing mechanism, the shock absorbing mechanism being arranged between the upper assembly and the lower assembly and being compressed between the assemblies in the locked position of the assemblies. This ensures a constant good cohesion between the first and the second assembly, since they are held together under biasing and thus are also held against one another in reliable manner when the clamping force is slightly decreased. In particular, this prevents a relative movement of the components to one another.

It is also provided that a bayonet locking mechanism formed by the locking mechanism and the counter locking mechanism. Such a locking mechanism can be locked without exerting pressure in the joining direction.

Furthermore, it is provided that a rotating of the locking mechanism with respect to the counter locking mechanism also results in the locking mechanisms coming closer together in the direction of the axis of rotation thanks to guiding bevels formed between the two locking mechanisms. In this way, a clamping in the joining direction is possible by a rotary movement, so that an unwanted pressing force in the joining direction is reliably avoided during the joining process.

Furthermore, it is provided that a locking mechanism formed by the locking mechanism and the counter locking mechanism is outfitted with a detent mechanism, by which the locking mechanisms are held in their locking position with increased force. This effectively prevents a releasing of the locking even under strong vibrations, such as, for example, when driving over unpaved roads.

It is also provided a toggle locking mechanism formed by the locking mechanism and the counter locking mechanism. In this way, a locking is possible simply by moving a lever, without having to exert force in the joining direction.

Furthermore, it is provided in the case of the toggle locking mechanism that the locking mechanism comprises a tie rod which is guided on the second component so as to be lengthwise displaceable and rotatable in the joining direction and a rotatable cam, the cam being mounted on the tie rod and rotatable transversely to the joining direction, and the locking mechanism is braced by the cam against the second component. In this way, it is possible to clamp together the first and the second component by a rotating of the cam about an axis of rotation lying transversely to the joining direction. Also in this way an unwanted pressing force in the joining direction is reliably avoided during the joining process.

Moreover, it is provided that the second assembly is designed as a control device. Thus, the antenna module can be adapted in its capability to the number of antennas installed with the first assembly in modular fashion.

By coaxial connections is meant in the sense of the present invention connection elements such as plugs, sockets, or the like.

The terms assembly and component are used synonymously in the sense of the present invention.

### BRIEF DESCRIPTION OF THE DRAWINGS

Further details of the invention will be described in the drawing with the aid of schematically represented sample embodiments.

FIG. 1 is a first variant embodiment of an antenna module according to the present invention, wherein a lower assembly is still separate from an upper assembly;

FIG. 2 is an antenna module shown in FIG. 1, wherein the lower assembly has already made contact with the upper assembly and is held against the upper assembly;

FIG. 3 is an antenna module shown in FIGS. 1 and 2, wherein a locking mechanism is now also locked;

FIG. 4 is a second variant embodiment of an antenna module according to the present invention, wherein a lower assembly is still separate from an upper assembly;

FIG. 5 is an antenna module shown in FIG. 4, wherein the lower assembly has already made contact with the upper assembly and is held against the upper assembly;

FIG. 6 is an antenna module shown in FIGS. 4 and 5, wherein a locking mechanism is rotated by 90°;

FIG. 7 is an antenna module shown in FIGS. 4, 5 and 6, wherein the locking mechanism is now also locked;

FIGS. 8a to 8e illustrate a third variant embodiment of an antenna module according to the present invention; and

FIGS. 9a to 9j illustrate a fourth variant embodiment of an antenna module according to the present invention.

### DETAILED DESCRIPTION OF THE PRESENT INVENTION

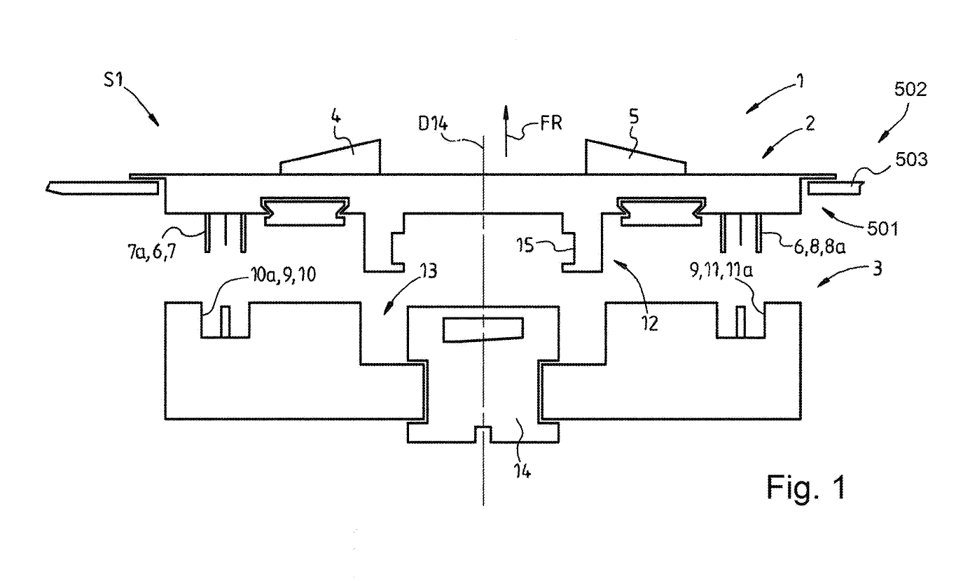

FIG. 1 shows a first variant embodiment of an antenna module 1 according to the present invention in schematic side view. The antenna module 1 comprises a first, upper assembly 2 and a second, lower assembly 3. The upper assembly 2 here is connected to two antennas 4, 5, which are arranged on the assembly 2. The assembly 2 is held in a roof cutout 501 of a vehicle 502, where only a portion of a roof 503 of the vehicle 502 is shown. The roof 503 forms a component of the vehicle body.

The upper assembly 2 comprises, as an electrical contact component 6, two coaxial connections 7, 8. The lower assembly 3 comprises, as an electrical contact component 9, two coaxial connections 10, 11. The lower assembly 3 is provided to be secured on the upper assembly 2 and is shown in FIG. 1 in a nonsecured position S1. The coaxial connections 7, 8 of the upper assembly 2 are designed as coaxial plugs 7a, 8a or so-called “male cable connectors”. The coaxial connections 10, 11 of the lower assembly 3 are designed as coaxial sockets 10a, 11a or so-called “female cable connectors”. The first assembly 2 comprises a centering mechanism 12 between the coaxial plugs 7a, 8a and projecting beyond the coaxial plugs 7a, 8a in a joining direction FR. The second assembly 3 comprises a receiving mechanism 13 for the centering mechanism 12 counter to between the coaxial sockets 10a, 11a. Furthermore, the second assembly 3 comprises a locking mechanism 14 and a counter locking mechanism 15. The locking mechanism 14 is able to be rotated by a rotation about an axis of rotation D14 extending in the joining direction without exerting a force that acts in the joining direction FR and locked to the counter locking mechanism 15 by a right-hand rotation or unlocked from the counter locking mechanism 15 by a left-hand rotation.

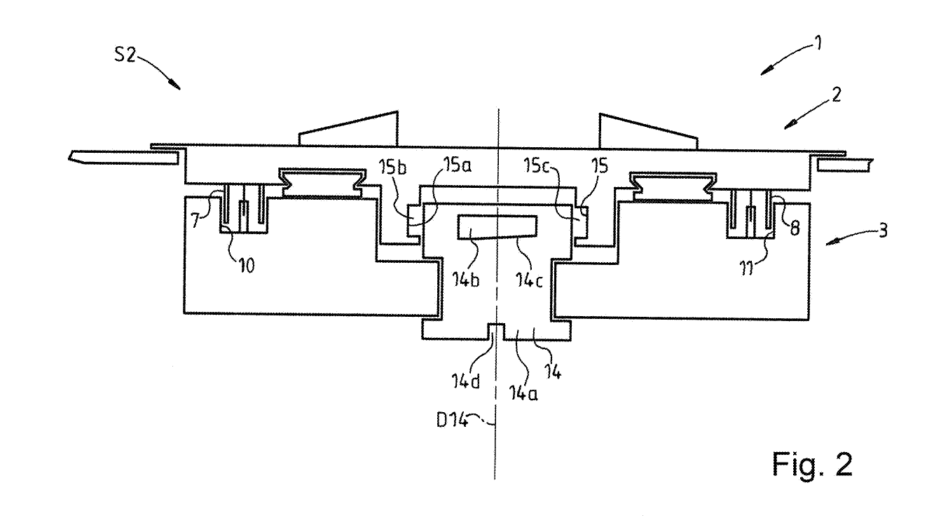

In FIG. 2, the second component 3 is shown in a half-mounted position S2. The second component 3 attains this position S2 by a plugging of the component 3 onto the first component 2 in the joining direction FR. The two components 2 and 3 are held together in this position by the coaxial connections 7 and 10 as well as 8 and 11 which respectively interact with each other. Thus, it is possible to premount the second component 3 by one hand on the first component 2 by a simple plugging on. During the premounting process, the locking mechanism 14, designed as a bayonet pin 14a mounted in the lower component 3 and able to rotate about the axis of rotation D14, is guided into the counter locking mechanism 15 fashioned on the first component 2. The counter locking mechanism 15 is designed as a receiving ring 15a, comprising two opposite recesses 15b and 15c, which are fitted to oppositely situated projections 14b and 14c of the locking means 14.

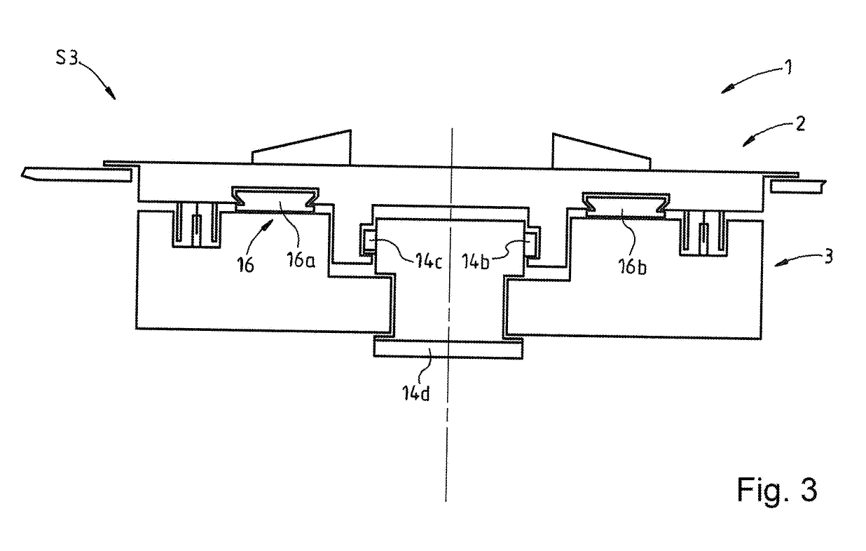

By a rotation of the locking mechanism 14, which can be actuated by a slot 14d, about a half-turn around the axis of rotation D14, the second component 3 comes into a mounted position or clamping position S3, which is shown in FIG. 3. By the rotation of the locking mechanism 14, the second component 3 is pulled against the first component 2, since the projections 14b and 14c are provided with guiding bevels 14e (see FIG. 2). The antenna module 1 comprises a shock absorbing mechanism 16, which is formed by two foam cushions 16a and 16b that are secured to the first component 2. The foam cushions 16a and 16b are elastically compressed upon actuation of the locking mechanism 14 and thereby secure the connection of the two components 2 and 3 by a loosening in the event of vibration.

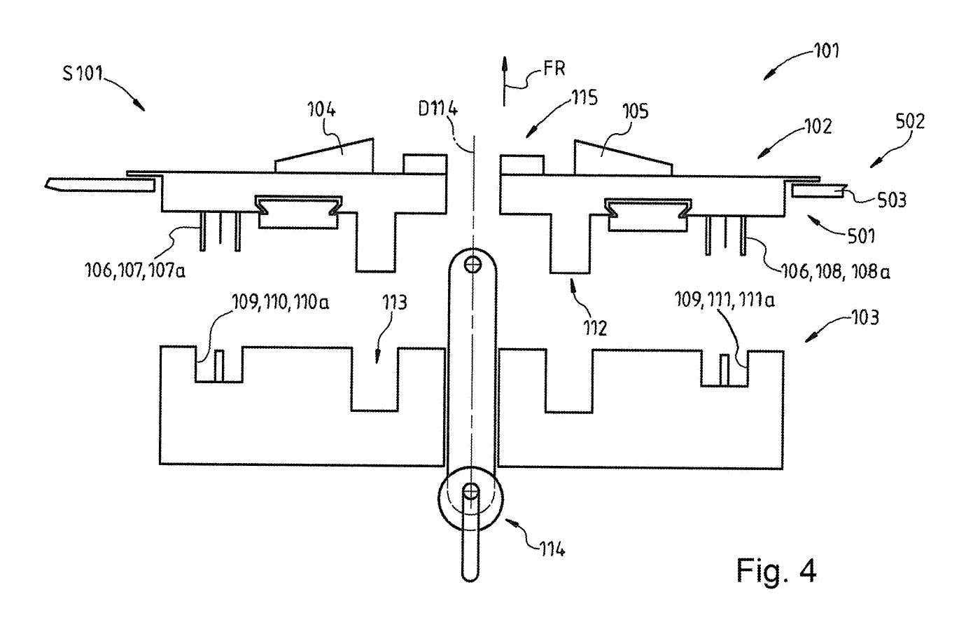

FIG. 4 shows a second variant embodiment of an antenna module 101 according to the present invention in schematic side view. The antenna module 101 comprises a first, upper assembly 102 and a second, lower assembly 103. The upper assembly 102 here is connected to two antennas 104, 105, which are arranged on the assembly 102. The assembly 102 is held in a roof cutout 501 of a vehicle 502, where only a portion of a roof 503 of the vehicle 502 is shown.

The upper assembly 102 comprises, as an electrical contact component 106, two coaxial connections 107, 108. The lower assembly 102 comprises, as an electrical contact component 109, two coaxial connections 110, 111. The lower assembly 102 is provided to be secured on the upper assembly 103 and is shown in FIG. 4 in a nonsecured position S101. The coaxial connections 107, 108 of the upper assembly 2 are designed as coaxial plugs 107a, 108a or so-called “male cable connectors”. The coaxial connections 110, 111 of the lower assembly 102 are designed as coaxial sockets 110a, 111a or so-called “female cable connectors”. The first assembly 102 comprises a centering mechanism 112 between the coaxial plugs 107a, 108a and projecting beyond the coaxial plugs 107a, 108a counter to a joining direction FR. The second assembly 103 comprises a receiving mechanism 113 for the centering mechanism 112 between the coaxial sockets 110a, 111a. Furthermore, the second assembly 103 comprises a locking mechanism 114 and a counter locking mechanism 115.

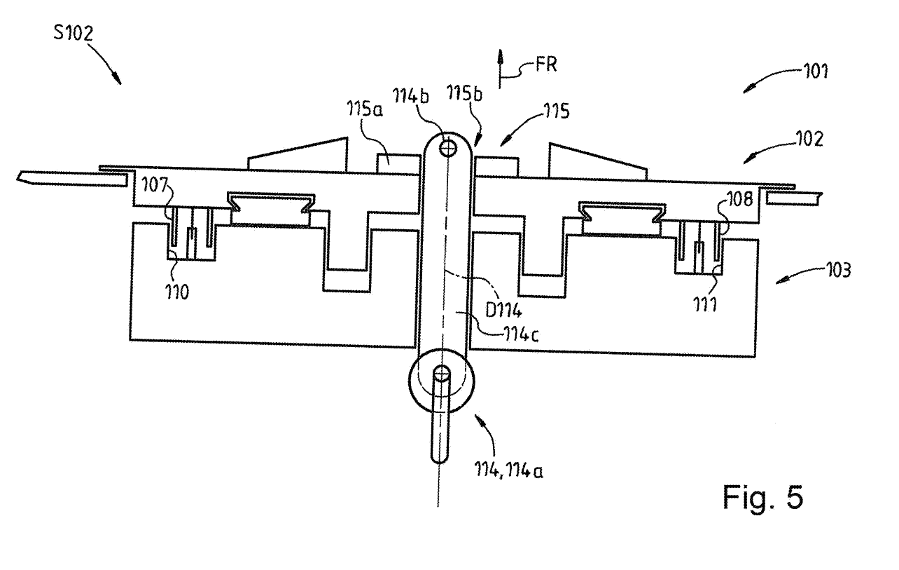

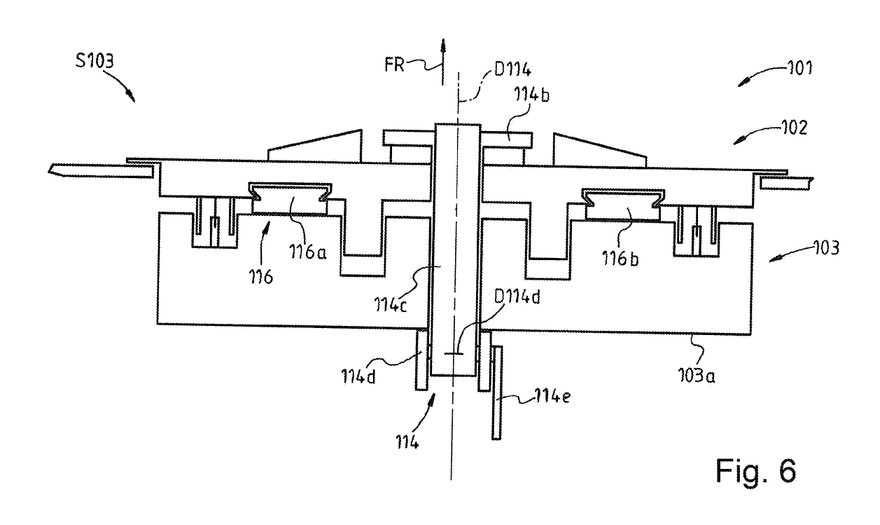

In FIG. 5, the second component 103 is shown in a half-mounted position S102. The second component 103 attains this position S102 by a plugging of the component 103 onto the first component 102 in the joining direction. The two components 102 and 103 are held together in this position S102 by the coaxial connections 107 and 110 as well as 118 and 111 which respectively interact with each other. Thus, it is possible to premount the second component 103 by one hand on the first component 102 by a simple plugging on. During the premounting process, the locking mechanism 114, designed as a toggle 114a mounted in the lower component 103 and able to rotate about the axis of rotation D114 running in the joining direction FR, is guided into the counter locking mechanism 115 fashioned on the first component 102. The counter locking mechanism 115 is designed as a plate 115a, comprising an aperture 115b, the aperture 115b being fitted to a cross arm 114b of a tie rod 114c of the locking mechanism 114. From the position S102 shown in FIG. 5, in which the cross arm 114b has already been shoved through the aperture 115b, the tie rod 114c in a further premounting step is rotated by 90° about the axis of rotation D114, so that the locking mechanism 114 stands in the second premounting position S103 shown in FIG. 6.

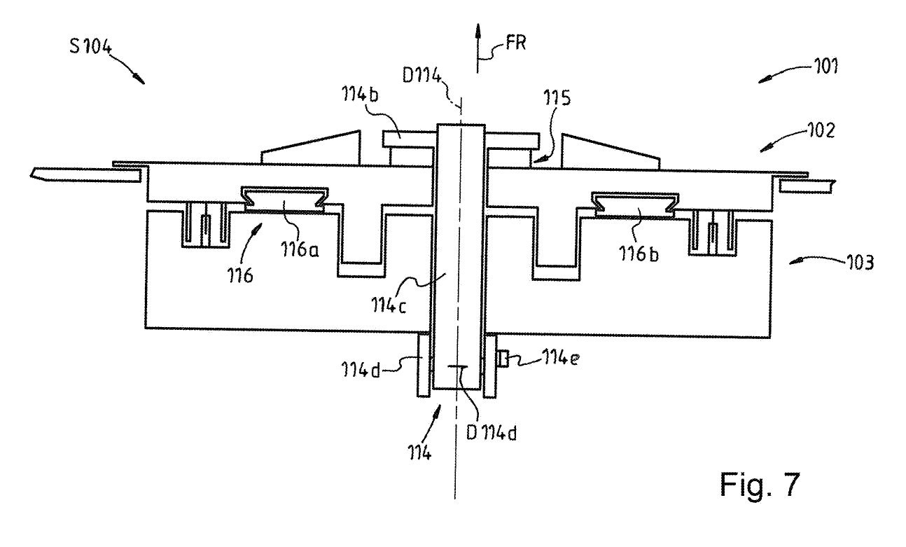

In this position S103, the locking mechanism 114 also lies against an underside 103a of the second component 103 by a cam 114d, which can rotate about an axis of rotation D114d running transversely to the joining direction FR or transversely to the axis of rotation D114. The cam 114d here can be actuated or rotated by means of a lever 114e. Thanks to a 90° rotation of the lever 114e into the plane of the drawing, the cam 114d is twisted so that the cam 114d pulls the second component 103 against the first component 102, being braced against the first component 102 by the tie rod 114c, during which a shock absorbing mechanism 116 formed by two foam cushions 116a and 116b secured on the first component 102 are elastically compressed. This mounting position S104 is shown in FIG. 7.

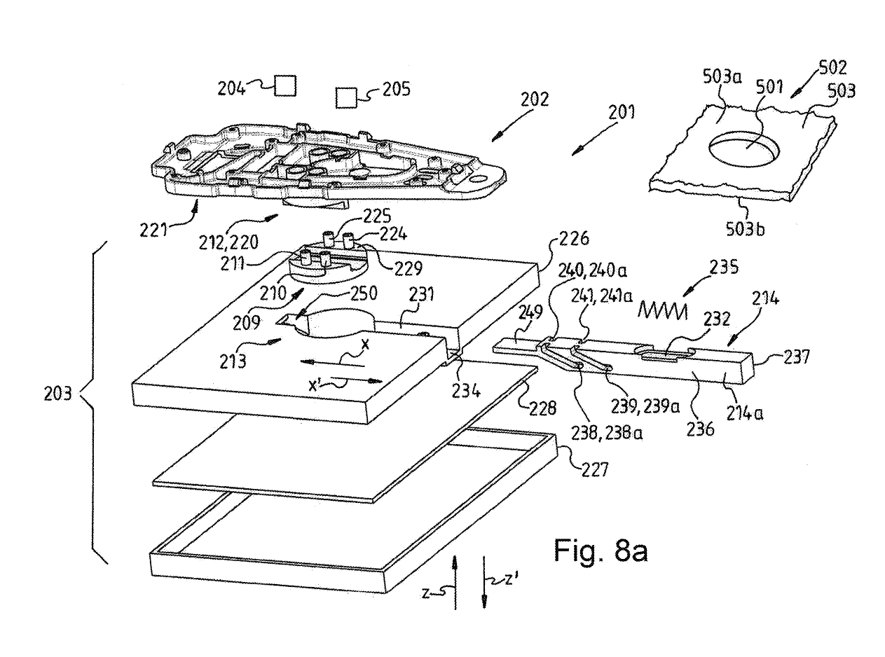

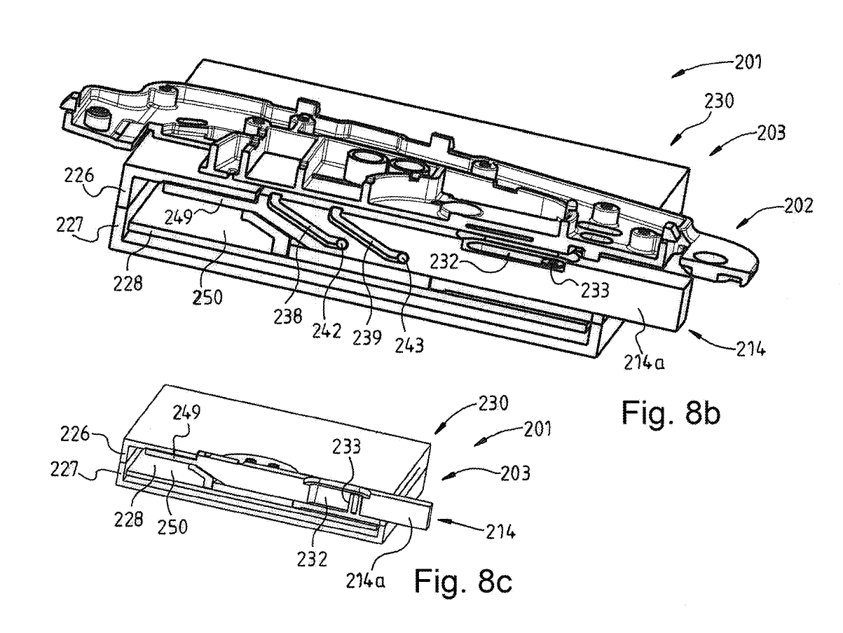

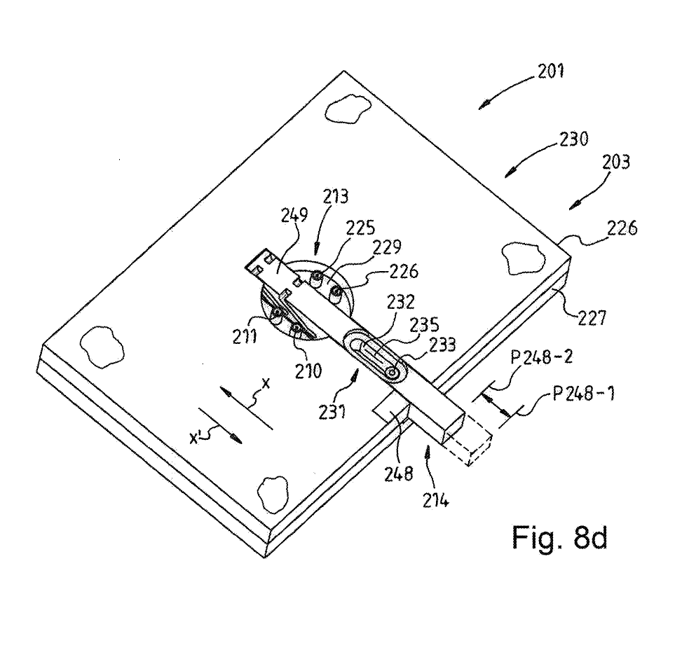

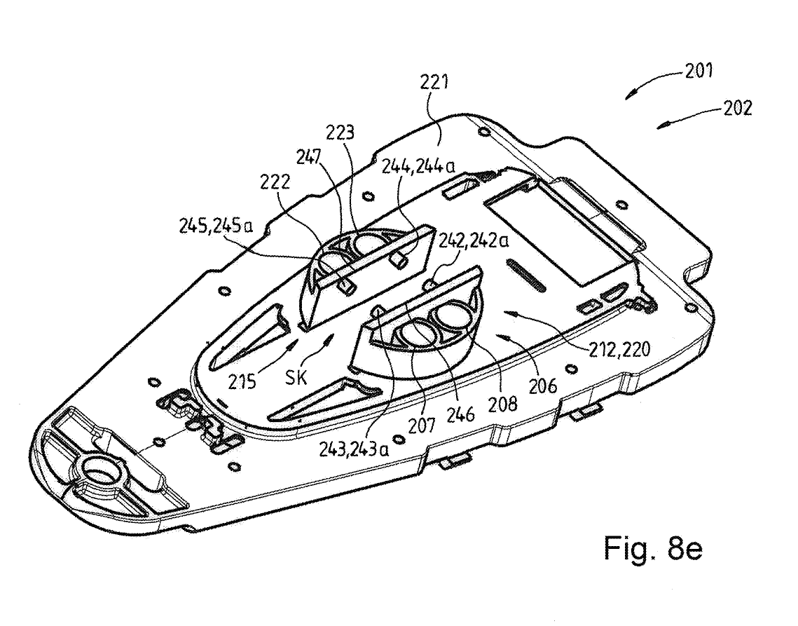

FIGS. 8a to 8e show a third variant embodiment of an antenna module 201 according to the present invention. The antenna module 201 comprises a first, upper assembly 202 and a second, lower assembly 203. Two antennas 204, 205 are arranged here beneath a covering (not shown) of the upper assembly 202. The upper assembly 202 reaches by a centering mechanism 212 or shoulder 220 through a roof cutout 501 of a roof 503 of a vehicle 502, only indicated schematically, and is thereby held in it. By a bearing surface 221 the upper assembly 202 lies against an exterior 503a of the roof 503. The upper assembly 202 comprises, as is evident from the representation of FIG. 8e, which shows the upper assembly 202 in a perspective bottom view, four coaxial connections 207, 208, 222, 223 as the electrical contact component 206. The lower assembly 203 comprises, as the electrical contact component 209, two coaxial connections 210, 211, 224, 225. The lower assembly 203 is intended to be secured to the upper assembly 202 with the roof 503 coming in between and it is shown in FIG. 8a in exploded view and in a nonsecured position. The lower assembly 203 comprises a housing top part 226, a housing bottom part 227, an electronics unit 228, a contact unit 229 and a locking mechanism 214. The lower assembly 203 is shown assembled in FIG. 8b, 8c and 8d. It can be seen from the longitudinal sections shown in FIGS. 8b and 8c that the electronics unit 228 is substantially accommodated in the housing bottom part 227 and that the locking mechanism 214 is guided as a slide 214a in the housing top part 226. The contact unit 229 in the assembled state of the lower assembly 203 is mechanically connected to a housing 230 formed from the housing top part 226 and the housing bottom part 227 and electrically connected to the electronics unit 228. The locking mechanism 114 is guided in a channel 231 formed on the housing top part 226. The locking mechanism 214 comprises an oblong hole-shaped aperture 232, which in the mounted state of the locking mechanism 214 accommodates a bolt 233 which is arranged on a bottom 234 of the channel 231. The locking mechanism 214 comprises a spring element 235, which in the mounted state of the locking mechanism 214 is received in the aperture 232 in front of the bolt 233 so that the spring element 235 pushes the locking mechanism 214 in the direction of the arrow x in the direction of the contact unit 229. In FIG. 8d, the spring element 235 is shown only schematically as a line. On a left lateral surface 236 and on a right lateral surface 237 moreover the locking mechanism 214 has each time two guiding mechanism 238a, 239a and 240a and 241a, which are fashioned as guiding grooves 238, 239, 240 and 241, running downward at a slant counter to the x direction in the x′ direction and in the z′ direction. These guiding grooves 238 to 241 are adapted to pins 242, 243, 244 and 245 which form counter guiding mechanisms 242a, 243a, 244a and 245a. These counter guiding mechanisms or pins are arranged on oppositely situated guide plates 246, 247 of the centering mechanism 212 or shoulder 220 of the upper assembly 202 (see FIG. 8e), while the guide plates 246, 247 form a slide channel SK. In the sectional view of FIG. 8b, both the guiding grooves 238, 239 and the pins 242, 243 can be seen. Thanks to a retaining mechanism 248 shown only schematically in FIG. 8d, the locking mechanism 214 is held against the spring element 235 in a biased position or clamping position P248-1, indicated by broken lines. For the premounting, the lower assembly 203 is moved upward in the arrow direction z, with the locking mechanism 214 standing in the biased position P248-1, against the shoulder 220 of the upper assembly 202, protruding through the roof cutout 501, so that the centering mechanism 212 or the shoulder 220 plunges into a receiving mechanism 213 formed on the lower assembly 203 and the coaxial connections 207, 208, 222, 223 of the lower assembly 203 and the coaxial connections 210, 211, 224, 225 of the upper assembly 202 are opposite each other. In this orientation of the lower assembly 203 to the upper assembly 202, in which the pins 242 to 245 also plunge into the guiding grooves 238 to 241, the retaining mechanism 248 is then activated for the mounting process, so that the spring element 235 shifts the locking mechanism 214 in the x direction and the locking mechanism 214 moves from the biased position P248-1 into a locked position or locking position P248-2. A counter locking mechanism 215 formed on the upper assembly 202 comprises the pins 242 to 245 in this case. The locking mechanism 214 for the guidance on the housing 230 plunges by a lug 249 deeper into a shaft 250 which is a prolongation of the channel 231. During this movement in the x direction, the lower assembly 203 is pulled by the locking mechanism 214 in the z direction or in a joining direction FR upward against the upper assembly 202, since the locking mechanism 214 is guided in linear manner in the x direction in the lower assembly 203 and the locking mechanism 214 can then only move relative to the pins 242 to 245 if the lower assembly 203 comes closer to the upper assembly 202, while the lower assembly 203 in its movement in the z direction is guided on the centering mechanism 212 or on the shoulder 220 of the upper assembly 202, so that this can only move in the z direction with the exception of the locking mechanism 214. Once the locking mechanism 214 has reached its position P248-2, the lower assembly 203 is fully mounted and in particular the coaxial connections 207, 208, 222, 223 of the lower assembly 203 and the coaxial connections 210, 211, 224, 225 of the upper assembly 202 are joined together. On the lower assembly 203, elastic cushions 251, 252, 253 and 254 are arranged on the housing top part 226, which when the lower assembly 203 is fully mounted bear under slight compression against an interior or underside 503b of the roof 503 and dampen any vibrations of the lower assembly 203 which may occur. Basically, the mounting of the lower assembly 203 on the upper assembly 202 is done in such a way that no joining force oriented in the z direction needs to be applied by the worker for the contacting of the assemblies. Instead, thanks to the force of the spring element 235, the lower assembly 203 is pulled by its own force against the upper assembly 202, without any significant force acting on the roof 503, so that permanent deformations of the roof 503 as a result of the mounting process are ruled out. This movement is produced in that the lower assembly 203 is guided in the z direction on the upper assembly 202 and the guiding grooves 238, 239 and 240, 241 move along with the locking mechanism 214 relative to the pins 242, 243, 244 and 245 in the z direction. A dismounting of the lower assembly 203 is done in that the locking mechanism 214 is pulled from its position P248-2 to its position P248-i and secured in this position by the retaining mechanism 248. Upon pulling back the locking mechanism 214 in the arrow direction x′, the lower assembly 203 is pressed off from the upper assembly 202, so that also during the dismounting no significant force is acting on the roof 503. Thus, a permanent deformation of the roof 503 as a result of a tensile force in a z′ direction exerted during the dismounting is also ruled out.

The coaxial connections 207, 208, 222, 223 of the upper assembly 202 are designed as coaxial plugs or so-called “male cable connectors”. The coaxial connections 210, 211, 224, 225 of the lower assembly 202 are designed as coaxial sockets or so-called “female cable connectors”.

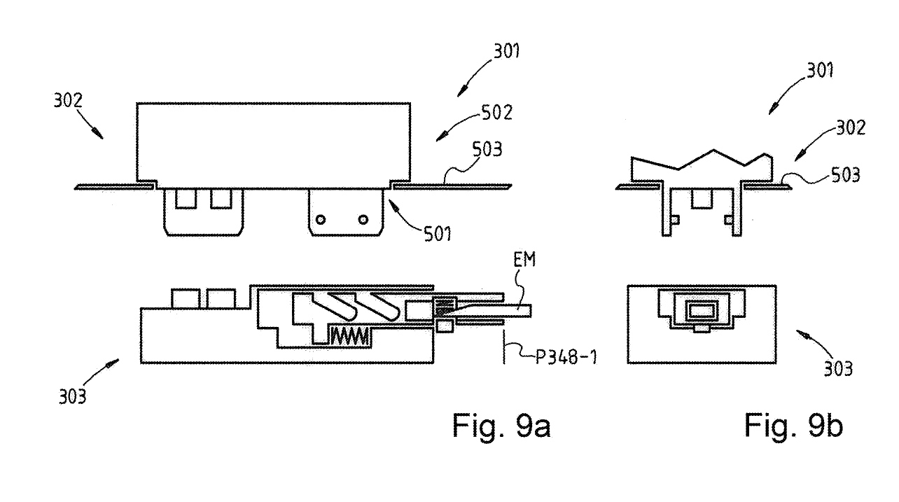

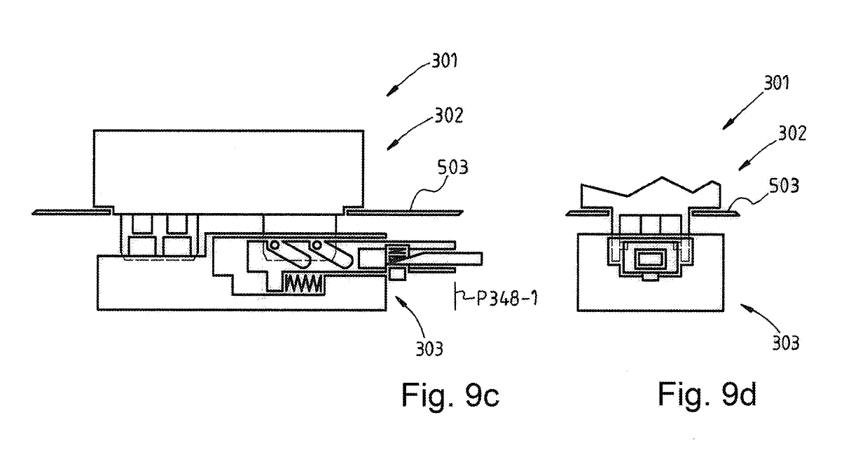

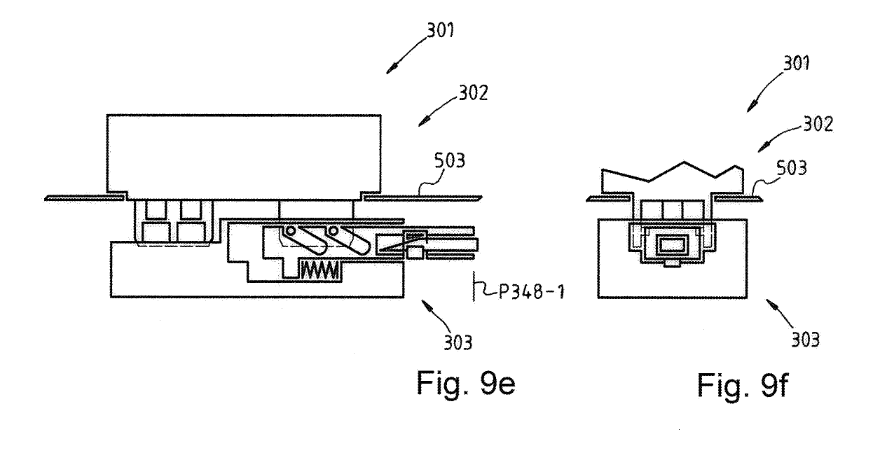

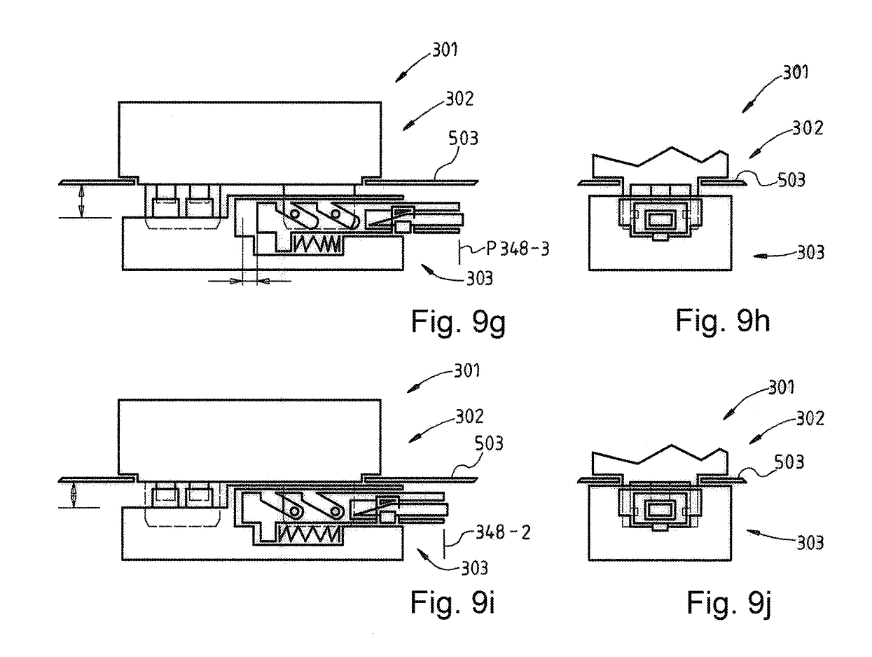

FIGS. 9a to 9j show for the schematic explanation of the movement sequence occurring during the third variant embodiment a fourth variant embodiment of an antenna module 301 according to the present invention, wherein the mounting of a lower component 303 on an upper component 302 is shown in side view, step by step, in FIGS. 9a, 9c, 9e, 9g and 9i and wherein the mounting of the lower component 303 on the upper component 302 in FIGS. 9b, 9d, 9d, 9h and 9j is shown in side view, step by step, from the right of the representations of FIGS. 9a, 9c, 9e, 9g and 9i. In all representations, each time a roof 503 of a vehicle 502 with a roof cutout 501 is also shown, through which a counter locking mechanism 315 of the upper component 302 protrudes. A locking mechanism 314 of the lower component is shown in a clamping position P348-1, a locking position P348-2 and an intermediate position P348-3 between these positions, the locking mechanism 314 being able to be loosened by a manual activating of an unlocking mechanism EM.

### LIST OF REFERENCE SYMBOLS

1 antenna module
2 first, upper assembly
3 second, lower assembly
4, 5 antenna
6 electrical contact component
7, 8 coaxial connection
7a, 8a coaxial plug
9 electrical contact component
10, 11 coaxial connection
10a, 11a coaxial socket
12 centering mechanism
13 receiving mechanism
14 locking mechanism
14a bayonet pin
14b, 14c projection
14d slot
14e guiding bevel
15 counter locking mechanism
15a receiving ring
15b, 15c recess
16 shock absorbing mechanism
16a, 16b foam cushions
D14 axis of rotation
FR joining direction
S1 nonsecured position
S2 half-mounted position
S3 mounted position or clamping position
101 antenna module
102 first, upper assembly
103 second, lower assembly
103a underside
104, 105 antenna
106 electrical contact component
107, 108 coaxial connection
107a, 108a coaxial plug
110a, 111a coaxial socket
109 electrical contact component
110, 111 coaxial connection
112 centering mechanism
113 receiving mechanism
114 locking mechanism
114a toggle
114b cross arm
114c tie rod
114d cam
114e lever
115 counter locking mechanism
115a plate
115b aperture
116 shock absorbing mechanism
116a, 116b foam cushions
201 antenna module
202 upper assembly
203 lower assembly
204, 205 antenna
206 electrical contact component
207, 208 coaxial connection
209 electrical contact component
210, 211 coaxial connection
212 centering mechanism
213 receiving mechanism
214 locking mechanism
214a slide
215 counter locking mechanism
220 shoulder
221 bearing surface of 202
222, 223 coaxial connection
224, 225 coaxial connection
226 housing top part
227 housing bottom part
228 electronics unit
229 contact unit
231 channel
232 oblong hole-shaped aperture
233 bolt
234 bottom of 231
235 spring element
236 left lateral surface of 214
237 right lateral surface of 214
238-241 guiding groove
238a-241a guiding mechanism
242-245 pin
242a-245a counter guiding mechanism
246, 247 guide plate
248 retaining mechanism
249 lug
250 shaft
251-254 elastic cushion
D114 axis of rotation
D114d axis of rotation
FR joining direction
P248-i biased position of 214 or clamping position
P248-2 locked position of 214 or locking position
S101 nonsecured position
S102 half-mounted position
S103 second premounting position
S104 mounting position
SK slide channel
x, x′ direction
z, z′ direction
501 roof cutout
502 vehicle
503 roof
503a exterior of 503
503b interior or underside of 503

1. An antenna module for a vehicle, comprising a first, upper assembly, which is connected to at least two antennas or comprises at least two antennas, and a second, lower assembly,
wherein the upper assembly comprises as an electrical contact component at least two coaxial connections,
wherein the lower assembly comprises as an electrical contact component at least two coaxial connections,
wherein the upper assembly is secured to a body component of the vehicle, and
wherein the lower assembly is positionable on and/or attachable to the upper assembly by a joining movement along a joining direction,
wherein the lower assembly comprises a locking mechanism,
the upper assembly comprises a counter locking mechanism,
wherein the locking mechanism is able to be locked to or unlocked from the counter locking mechanism, and
wherein the locking mechanism is able to be actuated so as to avoid, when actuating same, exerting a force that acts in said joining direction.

2. The antenna module as claimed in claim 1, wherein the coaxial connections of the upper assembly are designed as coaxial plugs and the coaxial connections of the lower assembly are designed as coaxial sockets.

3. The antenna module as claimed in claim 1, wherein the upper assembly comprises a centering mechanism between its coaxial connections and projecting beyond its coaxial connections counter to said joining direction, and
the lower assembly comprises a receiving mechanism for the centering mechanism between its coaxial connections.

4. The antenna module as claimed in claim 1, further comprising a shock absorbing mechanism arranged between the upper assembly and the lower assembly and being compressed between the assemblies in the locked position.

5. The antenna module as claimed in claim 1, further comprising a bayonet locking mechanism formed by the locking mechanism and the counter locking mechanism.

6. The antenna module as claimed in claim 5, wherein a rotating of the locking mechanism with respect to the counter locking mechanism results in the respective locking mechanisms coming closer together in the direction of an axis of rotation as a result of guiding bevels formed between the respective locking mechanisms.

7. The antenna module as claimed in claim 5, wherein the locking mechanism formed by the locking mechanism and the counter locking mechanism comprises a detent mechanism, by which the respective locking mechanisms are held in their locking position with increased force.

8. The antenna module as claimed in claim 1, further comprising a toggle locking mechanism formed by the locking mechanism and the counter locking mechanism.

9. The antenna module as claimed in claim 8, wherein the locking mechanism comprises a tie rod which is guided on the lower component so as to be lengthwise displaceable and rotatable in said joining direction and a rotatable cam, the cam being mounted on the tie rod and rotatable transversely to said joining direction, and the locking mechanism is braced by the cam against an underside of the lower component.

10. The antenna module as claimed in claim 1, wherein the locking mechanism is held in a clamping position relative to the second, lower assembly against a force of a spring element and wherein the locking mechanism when actuated can travel from its clamping position to a locking position driven by the spring element.

11. The antenna module as claimed in claim 10, wherein, due to an interworking of the locking mechanism with the counter locking mechanism, the lower assembly connected to the locking mechanism is pulled against the upper assembly by the locking mechanism traveling transversely to said joining direction in a linear manner such that coaxial connectors of the upper assembly and coaxial connectors of the lower assembly fully contact each other.

12. The antenna module as claimed in claim 10, wherein the locking mechanism comprises a slide that includes a guiding mechanism, wherein the counter locking mechanism comprises a slide channel that includes a counter guiding mechanism, and wherein the guiding mechanism steers the movement of the lower unit in said joining direction.

13. The antenna module as claimed in claim 12, wherein the guiding mechanism is formed by at least one guiding groove and wherein the counter guiding mechanism is formed by at least one pin.

14. The antenna module as claimed in claim 10, wherein the lower assembly comprises a retaining mechanism for releasing of the locking mechanism from its clamping position, wherein the retaining mechanism is activatable by the lower assembly coming close to a triggering means of the upper assembly and/or by a manual activation of a triggering mechanism arranged on the lower assembly.

15. The antenna module as claimed in claim 1, wherein the lower assembly is designed as a control device.

16. A vehicle roof-mounted antenna module comprising the antenna module of claim 1.
